(19) United States
(12) Patent Application Publication
(10) Pub. No.: US 2008/0022596 A1
(43) Pub. Date: Jan. 31, 2008

(54) DOOR SIGNALING SYSTEM

(76) Inventors: James C. Boerger, Franksville, WI (US); Kevin King, Mequon, WI (US); Timothy Lebens, Eden Prairie, MN (US); Glenn Manich, Mequon, WI (US); Ryan P. Beggs, Dubuque, IA (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/460,492

(22) Filed: Jul. 27, 2006

(51) Int. Cl. E05F 15/20

(52) U.S. Cl. 49/31; 49/70

(57) ABSTRACT

A door signaling system can warn a forklift driver on one side of a closed door that a pedestrian may be on the other side, thereby averting a collision between the forklift and the pedestrian. In some embodiments, the signaling system includes an elongate light prominently disposed along a perimeter of the doorway. In response to the pedestrian being at the door or in response to some other predetermined door-related event, the light warns the forklift driver of the situation or event. In some embodiments, the signaling system warns the driver by sounding a horn on the driver's vehicle or by shining a light upon tile door or against the floor.

### FIELD OF THE DISCLOSURE

The present disclosure generally pertains to a signaling system for use at a door and more specifically to a system for announcing a predetermined door-related event.

### BACKGROUND OF RELATED ART

Safety systems, such as those provided by Alert Safety Products, have been developed to warn pedestrians at doorways of approaching forklifts and other vehicles. The systems typically use strobe lights or illuminated signs that announce the oncoming vehicle so that pedestrians can react to avoid being struck. Although warning the pedestrian of oncoming vehicles can be helpful, such warnings may provide drivers with more confidence to speed, as drivers may discover that pedestrians are now less likely to step into their path. Even though the frequency of accidents may decline, the severity of those accidents would likely increase if they occurred at higher speeds.

Moreover, an illuminated sign or strobe light that is mounted above the door (e.g., at ceiling height) or off to one side of the door might not be noticed by pedestrians whose attention may be focused more centrally on the doorway through winch they are about to pass. In some cases, the sign may be misinterpreted as simply an arrow that indicates a direction for exiting the building or the direction they should travel after passing through the doorway, which, of course, could be disastrous, as that may lead them directly into an approaching forklift.

Consequently, a need exists for a better system for averting collisions between forklifts and pedestrians at doorways.

### SUMMARY

In some examples, a door signaling system at a doorway can warn a driver of a vehicle or other hazard about to pass through the doorway that a pedestrian may be at the other side of the door.

In some examples, an elongate light system disposed along at least a portion of a doorway's perimeter can provide an illuminated warning of a predefined door-related event.

In some examples, a light (e.g., flood light, spot light, laser, white, colored or flashing) can project a light beam upon the door or onto the floor as an illuminated warning of a predefined door-related event.

In some examples, a door signaling system provides an illuminated warning that pre-announces that the door is closing or is about to close.

In some examples, a door signaling system for warning a driver of a vehicle of the presence of a nearby pedestrian can distinguish a vehicle from a pedestrian.

In some examples, a visual or audible door signaling system is triggered only when at least two bodies (e.g., pedestrian and vehicle) are present at a doorway.

### BRIEF DESCRIPTION OF THE DRAWINGS

FIG. 1 is a perspective view of a door signaling system where the door is open.

FIG. 2 is a perspective view of the door signaling system of FIG. 1 but with the door partially open.

FIG. 3 is a perspective view of the door signaling system of FIG. 1 but with the door fully closed.

FIG. 4 is a perspective view similar to FIG. 3 but with no pedestrian at the door.

### DETAILED DESCRIPTION

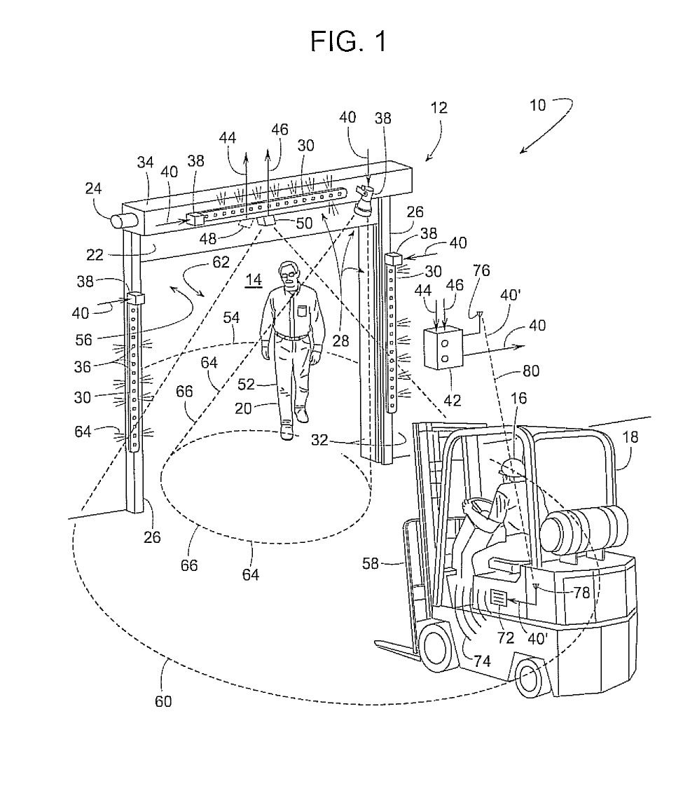

FIGS. 1-4 illustrate a door signaling system 10 that provides a warning for averting a collision between two bodies at opposites sides of a door 12 installed at a doorway 14. System 10 is particularly useful for alerting a driver 16 of a vehicle 18 (e.g., forklift or other moving hazard) that a pedestrian 20 is on the other side of doorway 14 and may be hidden from view due to the door being closed. Thus, system 10 is effective at communicating to a source of the hazard (i.e., the moving vehicle) that is likely to travel through the doorway about a potential danger, rather than warning the pedestrian that may imminently be in danger.

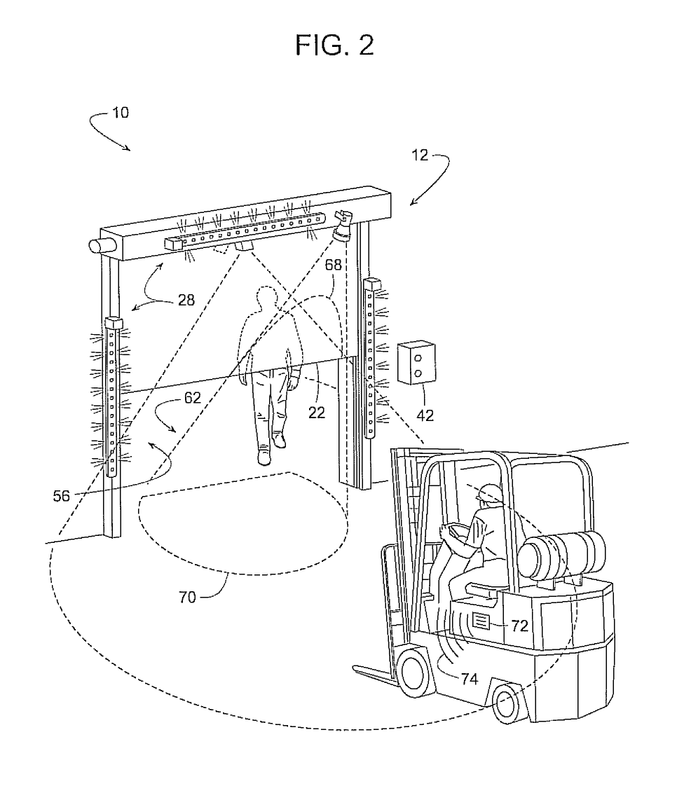

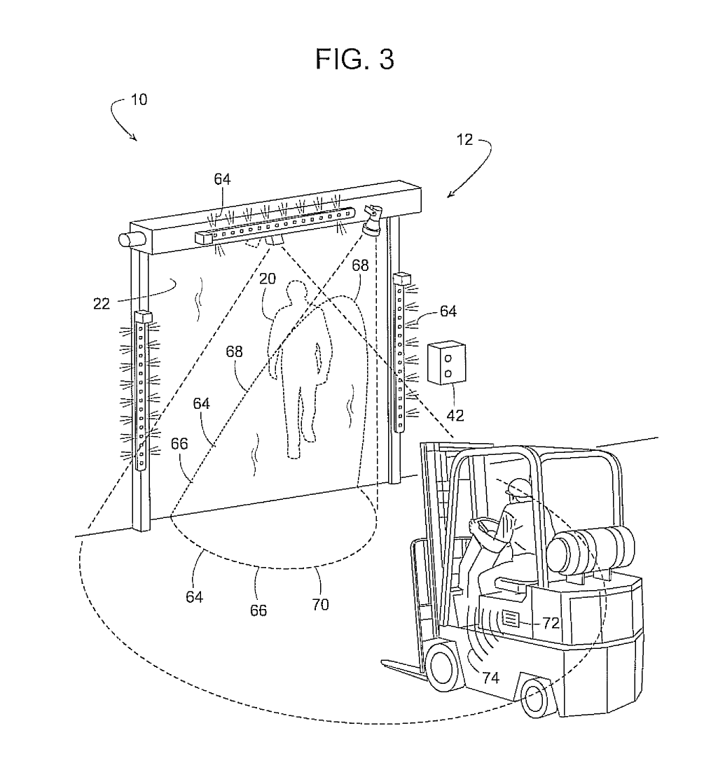

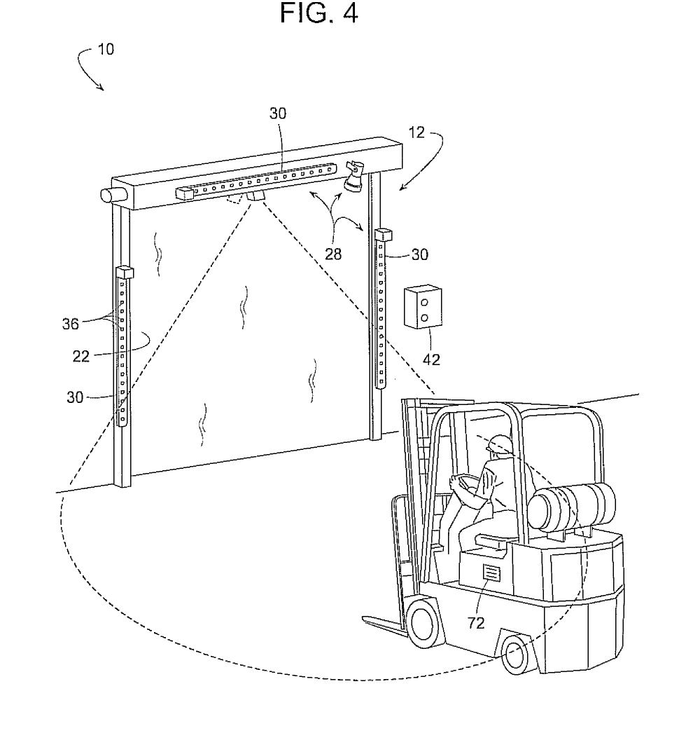

Although system 10 is shown applied to a door having a flexible vertically operating door panel 22, system 10 can be used for any type of door. For the illustrated example, door 12 opens and closes by a motor drive unit 24 rotating a take-up roller that draws in and pays out panel 22 to respectively open and close the door. Tracks 26 on either side of doorway 14 help guide the movement of panel 22. FIG. 1 shows door 12 fully open, FIG. 2 shows door 12 partially open, and FIGS. 3 and 4 show door 12 fully closed.

In one example, the warning provided by door signaling system 10 is an elongate light system 28 extending along at least a portion of a perimeter of doorway 14. Light system 28, for instance, may include one or more elongate lights 30 installed on either side of doorway 14, above doorway 14, along a lower edge of doorway 14, and/or on door 12, itself Elongate light 30 can be mounted to any convenient structure including, but not limited to, track 26, a wall 32 surrounding doorway 14, or a housing 34 that supports the flexible door panel's take-up roller. The elongation or length of light 30 may run generally parallel to the nearest edge of doorway 14 (i.e., lying generally vertical when installed along a lateral edge of the doorway and running generally horizontal when disposed along an upper edge of the doorway). Additionally, elongate lights 30, singularly or as a group, may be centrally distributed from left-to-right relative to doorway 14. In other words, in the illustrated examples, lights 30 are not biased off to one side of the doorway more than the other, as a person's attention is likely directed toward the center of the door that is about to open. In cases where only one light 30 is used, that light is may be mounted centrally above the doorway.

Logically, light system 28 may be particularly effective when it extends along all or most of the doorway's perimeter. For example, when mounted along the sides of doorway 14, elongate light 30 may desirably extend at least a third the height of the doorway, or better yet, at least half the doorway's height. When mounted along the top of the doorway, elongate light 30 may desirably extend at least half or at least a third the width of the doorway. For the greatest visual impact, light system 28 extends along most of the doorway's upper and lateral periphery.

While the aforementioned light mounting configurations may offer an easy, convenient, and effective solution, it may also be desirable to mount elongate light 30 in other locations along a portion of the door's perimeter. For example, elongate light 30 may be mounted on or in the floor at the door's threshold. A floor-mounted light may be desirable because a person's attention is typically directed toward the center of the doorway and often near the floor, because that is where they intend to travel. It may be desirable to have light system 30 be biased, such that it provides an indication of which side of the doorway a potential hazard lies.

Furthermore, it may also be desirable to mount elongate light 30 on door 12 itself. As noted above, a person who is moving toward or through a doorway typically directs his attention near the center of that doorway. When a door is closed or partially closed, as shown in FIGS. 2-4, a light 30 mounted on door 12 would be particularly effective at communicating information to such a person. While elongate light 30 could be positioned anywhere on the door, it may be most effective when placed on a lower portion of the door, as that is the last portion of the door to leave a person's view when the door is opening/rising (see FIG. 2). Methods for supplying power to devices, such as elongate light 30, mounted on a movable door include flexible, coiled cables and cables or wires with disconnectable connectors (to accommodate breakaway doors), among other things.

The actual structure of light 30 may vary. In some examples, light 30 is an elongate fixture containing a series of discrete lights 36, such as a series of LEDs typically found in conventional rope lights. Each light 30 may have its own electrical input 38, or lights 30 may share a common input, wherein a signal 40 conveyed to electrical input 38 is what actuates the lights.

In some examples, a controller 42 provides signal 40 in response to one or more input signals 44 and 46 from one or more sensors 48 and/or 50. Sensors 48 and 50 represent any device that can detect a certain door-related event at doorway 14. The term, “door-related event” represents any predefined occurrence within a certain vicinity of doorway 14. Sensor 48 may be a proximity sensor that can detect whether a first body 52 (e.g., pedestrian 90) is within a certain area 54 at a first side 56 of door 12, and sensor 50 can be a similar proximity sensor that can detect whether a second body 58 (e.g., vehicle 18) is within a certain area 60 at a second side 62 of door 12.

The actual design of sensors 48 and 50 may vary, as there are a wide variety of available sensors for detecting the presence and/or movement of a body, near a doorway. Examples of such sensors include, but are not limited to photoelectric eyes, proximity sensors, floor mat sensors, and motion detectors, which operate under various principles including, but not limited to, ultrasonics; active and passive detection of infrared radiation; lasers; detection of electromagnetic radiation (for example—sensing radio waves or sensing changes in capacitance or inductance or sensing the presence of RFID devices); and detecting a Doppler shift in microwaves. Thus, sensors 48 and 50 broadly represent any such sensor.

In some examples, sensors 48 and 50 can determine whether or not a sensed body is a vehicle. In other examples, however, sensors 48 and 50 just determine whether some body (vehicle, pedestrian, or otherwise) is at the doorway.

For the other examples, the door-related event can be defined as first body 52 being within area 54 at side 56 of the door. Upon detecting such a door-related event, sensor 48 provides signal 44 that activates light system 28 to present an illuminated warning 64. The illuminated warning can caution others on side 62 of the door that someone or something may be on the other side (side 56) of door 12. In this manner, door signaling system 10 communicates to a source of a hazard (e.g., a moving vehicle) near doorway 14 about a potential collision, rather than warning the object that may soon be in the greatest danger of bodily harm (e.g., a pedestrian). In some instances, it may be desirable to warn both parties. Toward that end, a similar elongate light system can be installed on side 56 of door 12 to warn those on that side of the door that a body 58 detected by sensor 50 may be on side 62 of the door.

In other examples, system 28 is considered to be in a WARNING-state when system 28 is projecting the illuminated warning 64 but is otherwise in a CLEAR-state. In the CLEAR-state, system 28 may be de-activated or may continue to be activated, projecting light of a different color. If light system 28 includes two different series of colored lights that can be independently activated, system 28 can be controlled to project red light during the WARNING-state and green light during the CLEAR-state. Alternatively, light system 28 might flash on and off while in the WARNING-state and do something else during the CLEAR-state. If light system 28 includes a series of discrete lights, die flashing of the light system referred to herein includes each of a series of lights individually flashing, all of them flashing simultaneously, or a series of them flashing in a predefined pattern. There are unlimited possible variations of using the lights to convey WARNING-states and CLEAR-states.

As used herein, activation of system 28 encompasses any change to the system's operating state, including the activation/de-activation of system 28, the illumination/de-illumination of the system, the changing of the colors illuminated/projected, the energization/de-energization of the system, the flashing of the system, the projection of an image, and other comparable changes the system's operational condition.

To avoid excessive activation of light system 28, such as when body 52 is at side 56 with no one at side 62 to see the illuminated warning, in some cases, the door-related event can be defined as both bodies 52 and 58 having to be present at opposite sides of door 12 in order to activate light system 28.

For examples that can distinguish vehicle 18 from other types of bodies, toe door-related event can be a combination of pedestrian 20 being at side 56 of the door and vehicle 18 being at side 6, wherein light system 28 is at side 62 of tie door.

In order to distinguish vehicle 18 from other types of bodies, sensors 48 and 50 might include a conventional inductive loop that is more sensitive to the presence of a body having a high metal content, as is typically the case with vehicles. Each sensor 48 and 50 can actually be a two-part sensor system, wherein one part detects pedestrians and the other part detects vehicles, or the first part detects a body and the second part determines whether it is a vehicle. Alternatively, sensors 48 and 50 may include an RFID receiver that can detect the presence of an RFID tag carried by vehicle 18. Of course, it could also be a pedestrian, rather than vehicle 18 that carries the RFID tag.

Another example well within the scope of the invention is sensor 50 being a motion sensor that provides activation signal 46 in response to detecting that vehicle 18 is not only in the vicinity of door 12 but is also approaching the door. In this case, the door-related event is pedestrian 20 being at side 56 of the door while vehicle 18 is at side 62 and is approaching the door, wherein light system 28 is at side 62 of door 12. A similar setup could be applied to sensor 48 on side 56.

In other examples, the door-related event can be a decision to close door 12, whereby activation of illuminated warning 64 could caution those in the area that the door is about to close. Such a door-related event could occur by pedestrian 20 or driver 16 actuating a conventional door-closing switch. Or, such a door-related event could take place automatically in response to pedestrian 20 or vehicle 18 passing through the doorway, or in response to a tinier.

An alternative to, or an addition to, activating elongate light system 28 in response to a door-related event is to provide a light system that can project a light beam 66 (e.g., flood light, spot light, laser, white light, colored light, or flashing light) when activated in response to a door-related event. System 28 could be activated, thereby projecting beam 66 onto door panel 22, as indicated by pattern 68 in FIGS. 2 and 3, and/or onto the floor, as indicated by pattern 70 in FIGS. 2 and 3. In addition to projecting a simple light beam (or as an alternative thereto), the system may also include a projector for projecting an image onto door panel 22 and/or the floor when activated.

Another alternative or addition to system 28 would be to activate a horn 72 carried by vehicle 18. Horn 72 could provide an audible warning signal 74 when activated in response to sensing a door-related event. To communicate a signal 40′ (comparable to signal 40) to horn 72, controller 42 can include a signal transmitter 76 and vehicle 18 can include a signal receiver 78 to create a wireless communication link 80 between the two. FIGS. 1-3 show horn 72 in a WARNING-state, and FIG. 4 shows horn 72 in a CLEAR-state. Similarly, an audible warning of another type (e.g., a voice system) could also be used with the system (as an alternative to the horn) to provide an audible warning in response to the sensing of a door-related event. In this manner, door signaling system 10 communicates to a source of a hazard (e.g., vehicle 18) near doorway 14 about a potential collision.

Although the invention is described with respect to various examples, modifications thereto will be apparent to those of ordinary skill in the art. The control schemes described with reference to elongate light system 28, for instance, can be readily applied to light beam 66 and horn 72. Furthermore, while the door signaling system has been discussed primarily for use when a pedestrian is on one side of a doorway and a vehicle is on the other side, it would also find utility when a vehicle (or even pedestrian) is on each side of the doorway. Door signaling system 10 would also be useful mounted on either a “pedestrian side” or a “vehicle side” of doorway 14, or both. The scope of the invention, therefore, is to be determined by reference to the following claims:

1. A door signaling system responsive to a door-related event at a doorway, the doorway includes a door defining a first side of the door and a second side of the door, the door signaling system comprising:
an elongate light system extending along at least a portion of a perimeter of the doorway and being activated in response to a signal indicative of die door-related event.

2. The door signaling system of claim 1, wherein when elongate light system is activated it provides an illuminated warning.

3. The door signaling system of claim 1, further comprising a sensor that provides the signal in response to sensing the door-related event,

4. The door signaling system of claim 1, wherein the door-related event is a pedestrian being at the first side of the door.

5. The door signaling system of claim 1, wherein the door-related event is a pedestrian being at the first side of the door, and the elongate light system is at the second side of the door.

6. The door signaling system of claim 1, wherein the door-related event is a combination of a pedestrian being at the first side of the door and a vehicle being at the second side of the door, wherein the elongate light system is on the second side of die door.

7. The door signaling system of claim 1, wherein the door-related event is a pedestrian being at the first side of the door while a vehicle is at the second side of the door and is approaching the door, wherein the elongate light system is at the second side of lie door.

8. The door signaling system of claim 1, wherein the door-related event is a combination of a first vehicle being at the first side of the door and a second vehicle being at the second side of the door.

9. The door signaling system of claim 1, wherein the elongate light system is disposed along two lateral edges of the doorway.

10. The door signaling system of claim 1, wherein the elongate light system is disposed along an upper edge of the doorway.

11. The door signaling system of claim 1, wherein the elongate light system is disposed along a lower edge of the doorway.

12. The door signaling system of claim 1, wherein the door-related event is a decision to close the door, whereby activation of the elongate light system indicates the door might close.

13. The door signaling system of claim 2, wherein the illuminated warning can selectively be one of a first illuminated warning and a second illuminated warning, wherein the first illuminated warning is distinguishable from the second illuminated warning.

14. The door signaling system of claim 13, wherein the first illuminated warning and the second illuminated warning are distinguishable by color.

15. The door signaling system of claim 1, wherein the door-related event is a pedestrian being within a predefined area at the first side of the door.

16. The door signaling system of claim 1, wherein the door-related event is a vehicle being within a predefined area at the first side of the door.

17. The door signaling system of claim 1, wherein a portion of the elongate light system is attached to the door.

18. A door signaling system responsive to a door-related event at a doorway, the doorway includes a door defining a first side of tie door and a second side of the door, the door-related event is a pedestrian being present at the first side of the door, the door signaling system comprising:
a light system projecting a light beam onto the second side of the door in response to a signal indicative of the door-related event.

19. The door signaling system of claim 18, further comprising a sensor that provides the signal in response to sensing die door-related event.

20. The door signaling system of claim 18, wherein the light beam can selectively be one of a first light beam and a second light beam, wherein the first light beam is distinguishable from the second light beam.

21. The door signaling system of claim 20, wherein die first light beam and the second light beam are distinguishable by color.

22. The door signaling system of claim 21, wherein the door-related event is the pedestrian being at the first side of the door.

23. A door signaling method for avoiding a collision between a first body that might be at a first side of a door and a second body that might be at a second side of the door, the method comprising:
determining whether the first body is at the first side of the door;
determining whether the second body is at the second side of the door;
activating a signal selectively operable in a WARNING-state and a CLEAR-state;
operating the signal in the WARNING-state when both the first body and the second body are respectively at the first side and second side of the door; and
operating the signal in the CLEAR-state in response to either only one of the first body or the second body being respectively at the first side and the second side of the door or neither body being present on either side of the door.

24. The door signaling method of claim 23, wherein the signal is audible.

25. The door signaling method of claim 24, wherein the signal is activated by a horn carried by the vehicle.

26. The door signaling method of claim 23, wherein the first body is a pedestrian and the second body is a vehicle.

27. The door signaling method of claim 23, wherein the first body is a first vehicle and the second body is a second vehicle.

28. A door signaling system responsive to a door-related event at a doorway, the doorway includes a door defining a first side of the door and a second side of the door, the door-related event is a pedestrian being present at the first side of the door, the door signaling system comprising:
a projector projecting an image onto the second side of the door in response to a signal indicative of the door-related event.

29. The door signaling system of claim 28, further comprising a sensor that provides the signal in response to sensing the door-related event.

30. The door signaling system of claim 28, wherein the door-related event is the pedestrian being at the first side of the door.
